(19) United States
(12) Patent Application Publication
(10) Pub. No.: US 2021/0359360 A1
(43) Pub. Date: Nov. 18, 2021

(54) ACCUMULATOR

(71) Applicant: Mahle International GmbH, Stuttgart (DE)

(72) Inventors: Ingo Haeusler, Esslingen (DE); Dierk Hoffmann, Leonberg (DE); Ruediger Knauss, Kernen i.R. (DE)

(21) Appl. No.: 17/315,352

(22) Filed: May 9, 2021

(30) Foreign Application Priority Data
May 12, 2020 (DE) 102020205930.6

(51) Int. Cl. H01M 10/6567; H01M 10/6556; H01M 50/317

(52) U.S. Cl. CPC H01M 10/6567; H01M 50/317; H01M 10/6556

(57) ABSTRACT

An accumulator for a motor vehicle is disclosed. The accumulator includes at least one rechargeable accumulator cell and a housing where the accumulator cell is arranged in an interior space of the housing. The housing has a top and a bottom located opposite the top. The interior space is filled with a temperature-control liquid during operation, which surrounds and temperature-controls the accumulator cell. A vent opening is provided on the bottom for venting the interior space. A channel body is providing having at least one lower opening and at least one upper opening. The lower opening being fluidically connected to the vent opening. The upper opening is fluidically connected to a gas collection space in the interior space that is spaced apart from the bottom towards the top, so that a flow path extends between the gas collection space and the vent opening through the channel body.

### CROSS-REFERENCE TO RELATED APPLICATION

This application claims priority to German Application No. 10 2020 205 930.6 filed on May 12, 2020, the contents of which are hereby incorporated by reference in its entirety.

### TECHNICAL FIELD

The present invention relates to an accumulator for a motor vehicle, which comprises at least one rechargeable accumulator cell and a housing, in which the accumulator cell is arranged. The invention, furthermore, relates to a motor vehicle having such an accumulator.

### BACKGROUND

Accumulators serve for the electrical supply of various applications and are increasingly employed in motor vehicles in order to drive the motor vehicle. Such accumulators usually comprise accumulator cells which can be combined into cell modules. Generally, the accumulator cells are arranged in a housing of the accumulator.

Such an accumulator having multiple accumulator cells is known for example from DE 10 2018 215 036 A1.

Rising power demands on such accumulators require a temperature-control, i.e. a cooling and/or a heating of the accumulator, in particular of the accumulator cells.

From DE 10 2012 221 694 A1 an accumulator having multiple accumulator cells is known, which are arranged in a housing. For temperature-controlling the accumulator cells, the housing is flowed through by air. Here, DE 10 2012 221 694 A1 proposes providing the housing with pipe branches which discharge gases developing during the operation of the accumulator cells of the accumulator.

The present invention deals with the object of stating for an accumulator of the type mentioned at the outset and for a motor vehicle having such an accumulator, improved or at least other embodiments, which are characterized in particular by an increased efficiency with simple operation and simple maintenance at the same time.

According to the invention, this object is solved through the subjects of the independent claim(s). Advantageous embodiments are subject of the dependent claims.

### SUMMARY

The present invention is based on the general idea of filling an accumulator for temperature-controlling accumulator cells of the accumulator with a liquid temperature-control medium, in the following also referred to as temperature-control liquid and letting out gas located and accumulating due to gravity in an upper region of the housing by way of a lower side of the housing located opposite the upper region, i.e. venting the housing via the lower region. The filling of the housing with the temperature-control liquid for temperature-controlling the accumulator cells allows a reliable and efficient temperature-controlling, i.e. cooling and/or heating, of the accumulator cells, so that the accumulator can be more efficiently operated even with elevated operating voltages. The venting in the lower region allows a simplified access to the accumulator for the purpose of venting, so that the mounting and the maintenance of the accumulator can take place in a simplified manner. In particular, the lower region of the accumulator in the associated application is usually more easily accessible than the upper region, so that in this way the maintenance is made possible in the first place or substantially simplified.

According to the inventive idea, the accumulator comprises at least one rechargeable accumulator cell. Furthermore, the accumulator comprises the housing which delimits an interior space within the housing. Here, the at least one accumulator cell is arranged in the interior space. The housing has a top and a lower side located opposite the top. During the operation, the interior space is filled with the temperature-control liquid which surrounds the at least one accumulator cell and temperature-controls the accumulator cell in this way. According to the invention, the housing has a vent opening for venting the interior space on the lower side, i.e. for letting gas out of the interior space. The vent opening is fluidically connected, via a channel body, to a gas collection space in the interior space of the housing, which is arranged in the region of the top. With the channel body, gas can thus be let out of the intermediate space, in particular out of the gas collection space via the vent opening and the interior space thus bled. Thus, the gas collection space is spaced apart from the bottom towards the top in a spacing direction from the bottom towards the top. The channel body comprises at least one lower opening which is fluidically connected to the vent opening. Furthermore, the channel body comprises at least one upper opening which is fluidically connected to the gas collection space. Thus, a flow path extends between the gas collection space and the vent opening through the channel body.

The bottom of the housing is practically that side which in the associated application, for example in a state of the accumulator attached to an associated motor vehicle, is arranged in a height direction, in particular with respect to the vertical direction, at the bottom. Compared with this, the top of the housing is arranged, in the height direction and/or with respect to the vertical direction, above the bottom. Practically, the top and the bottom delimit the interior space. Practically, the gas collection space, furthermore, is delimited by the top.

The temperature-control liquid can generally be any liquid with which the at least one accumulator cell can be temperature-controlled.

Preferably, the temperature-control liquid is dielectric in order to prevent an electric interaction between the temperature-control liquid and the at least one accumulator cell or at least reduce the relevant risk as much as possible. “Liquid” in this case is to also mean oils.

As mentioned above, the interior space of the housing is filled with the temperature-control liquid for temperature-controlling the at least one accumulator cell. This means in particular that at least one accumulator cell is immersed in the temperature-control liquid. Here it is conceivable that the interior space of the housing is flowed through by the temperature-control liquid during the operation, wherein the at least one accumulator cell is surrounded by and thus temperature-controlled by way of the temperature-control liquid flowing through the interior space.

Basically, the channel body can extend at least partly outside the housing, in particular outside the interior space.

Preferred embodiments provide that the channel body extends at least partly, preferably completely, within the housing, in particular the interior space.

Basically, the channel body can be configured in any way provided it has at least one upper opening and at least one lower opening.

Practically, the at least one upper opening and/or the at least one lower opening are spaced apart from one another along the channel body. Preferably, the at least one lower opening and the at least one upper opening are arranged along the extension of the channel body on the front side of the channel body. In particular, at least one of the at least one lower openings can be arranged, for example formed at a lower end, and/or at least one of the at least one upper openings at an upper end of the channel body.

The channel body can be designed flexibly. In particular, the channel body can be a hose or comprise a hose.

Alternatively, the channel body can also be designed rigidly. Thus, the channel body can in particular be a tubular body or comprise a tubular body.

Obviously, the channel body can also be flexible in sections and rigid in other sections. In particular, the channel body can comprise both a hose and also a tubular body, which are arranged in particular in succession.

However, the channel body need not necessarily be embodied separately, in particular completely separately. It can also be at least partly integrated in other components already present in the interior of the housing. Preferentially, the channel body can also be formed within for example hollow chamber profiles or tie rods, which serve for example for stiffening the device.

The gas collection space is practically fluidically connected to the interior space, advantageously part of the interior space. Preferably, the gas collection space additionally delimited by a surface of the temperature-control liquid during the operation, i.e. in the state filled with the temperature-control liquid.

In the spacing direction from the bottom to the top the gas collection space is preferably the topmost region of the interior space, i.e. maximally distant in the spacing direction. Here it is preferred when the housing on the top has a curvature shaped towards the outside, which delimits the gas collection space towards the top. Alternatively or additionally, the top of the housing can rise towards the gas collection space. Thus, the interior space can be bled more easily and efficiently.

It is advantageous when the upper opening leads into the gas collection space, in particular is arranged in the gas collection space. In this way it is possible to vent the gas collection space and thus the interior space of the housing with increased efficiency.

Preferably, at least one of the at least one lower openings, advantageously the respective lower opening, leads into the outlet opening. Thus, the accumulator can be easily and cost-effectively produced and efficiently bled.

It is conceivable that at least one of the at least one lower openings of the channel body corresponds to the outlet opening.

Basically, the vent opening can be formed and/or arranged in any way on the bottom of the housing. In particular it is conceivable that the vent opening is formed in the bottom of the housing.

The venting of the interior space via the channel body and the vent opening can take place in the state of the interior space filled with the temperature-control liquid, in order to let out, in particular convey, for example extract excess and/or undesirable gases from the interior space.

The venting of the housing via the channel body and the vent opening can, furthermore, take place during the filling of the interior space with the temperature-control liquid. In the process, the temperature-control liquid introduced into the interior space displaces gas out of the interior space via the channel body and the vent opening. Thus it is ensured that the interior space is filled with the temperature-control liquid as completely as possible. Here, the interior space can be filled with temperature-control liquid until temperature-control liquid flows out of the vent opening.

The respective, at least one accumulator cell, can basically be designed in any way provided it is rechargeable. The respective accumulator cell can be in particular a pouch cell, a prismatic cell and the like.

Preferred are embodiments, in which the accumulator comprises a valve for opening and blocking the flow path and thus for allowing and interrupting the venting via the vent opening. The valve, in the following also referred to as vent valve, is adjustable between a venting position, in which the vent valve opens the flow path, and a blocking position, in which the vent valve blocks the flow path. Thus, a venting of the interior space in particular to suit requirements is thereby made possible. In particular it is thereby possible to allow the venting of the interior space during the filling with the temperature-control liquid and/or during the maintenance of the accumulator and otherwise interrupt the same. In addition, a venting of the interior space can thus be carried out when the pressure within the interior space, in particular within the gas collection space, exceeds a predetermined value. Here, the adjusting of the vent valve between the venting position and the blocking position can take place axially and/or radially and/or in the circumferential direction, i.e. for example by turning, pulling, pushing or screwing.

In preferred embodiments, the accumulator comprises a drain opening for draining temperature-control liquid out of the interior space. The drain opening is practically arranged, in particular formed, on the bottom of the housing. Thus it is possible to drain temperature-control liquid out of the interior space when required, for example during the maintenance of the accumulator.

The arrangement of the drain opening on the bottom allows a simple, reliable and efficient draining of temperature-control liquid out of the accumulator. In particular, the drain opening is arranged at the lowest point of the interior space, in particular on the bottom, so that the bottom forms a sump for the temperature-control liquid directed towards the drain opening.

Furthermore, the accumulator preferably comprises a drain valve with which the draining of temperature-control liquid out of the interior space can be opened and blocked. The drain valve is adjustable between a draining position, in which a drainage path of the temperature-control liquid between the interior space and the drain opening is opened, and a closing position, in which the drainage path is blocked.

Basically, the drain valve can be designed in any way.

For example, the drain valve can comprise a drain closure, for example a plug and/or a screw, wherein the drain closure is adjustable between the draining position and the closing position. In particular, the drain valve can be the drain closure, i.e. the drain valve be formed as a drain closure. Thus, a simple implementation of the drain valve is realised.

Basically, the vent opening can be separate and spaced apart from the drain valve and/or from the drain opening.

Conceivable are embodiments in which the vent opening is formed in the drain valve. Thus, the access to the accumulator both for venting and also for draining temperature-control liquid is combined and consequently simplified.

It is preferred when the drain valve is formed as a drain closure, for example as a plug and/or a screw, in particular a screw head, and the vent opening is formed in the drain closure. Here, the channel body is at least partly formed so as to be deformable and flexible. This results in that the relative positioning of at least one of the at least one upper openings in the interior space or towards the gas collection space does not change when the drain valve is adjusted. For this purpose, the channel body is fixed relative to the gas collection space preferably in the region of the upper opening. Thus, the venting and the draining of temperature-control liquid out of the interior space can take place individually and independently of one another.

It is preferred when in the draining position of the drain valve the flow path is open. In this way gas, in particular air, can flow, during the draining of temperature-control liquid of the interior space, from the surroundings of the housing into the interior space and thus simplify the drainage of the temperature-control liquid out of the interior space. In particular, an even drainage of the temperature-control liquid out of the interior space is achieved in this manner since a sucking-in of ambient air through the drain opening and thus a temporary interruption of the flow of temperature-control liquid is prevented or at least reduced.

Alternatively it is conceivable to combine the vent opening and the drain opening. This means that the vent opening corresponds to the drain opening. In this way, the manufacture of the accumulator is simplified and/or a simpler maintenance of the accumulator is permitted.

The drain opening and the vent opening can be arranged, in particular formed in a common connector of the accumulator.

Preferably, the channel body is routed in the connector and fulfils the function of the drain valve. This means that the channel body forms or at least comprises the drain valve and is adjustable in the connector between the draining position and the closing position. Thus, the channel body is at least partly adjustable in the connector, wherein the connector forms in particular a guide channel for the drain valve or the channel body. This leads to a simplified configuration of the accumulator and a simplification of the maintenance of the accumulator.

Advantageously, the channel body comprises a lower section which forms the drain valve and is movably arranged in the connector. Furthermore, the channel body comprises an upper section which, on the side of the lower section facing the top, follows the lower section and has an outer cross section reduced in size. This means that the upper section has an outer cross section that is smaller than the outer cross section of the lower section. Here, the upper section of the channel body can comprise at least one of the at least one upper openings. When adjusting the lower section serving as drain valve into the draining position, the channel body is moved in the process in such a manner that the upper section is moved in the direction of the lower section, so that a cross section previously blocked in the connector by the lower section is at least partly opened. Consequently, a flow of temperature-control liquid out of the interior space is permitted, i.e. the drainage path opened.

The lower section is preferably formed in the manner of a collar, is in particular a collar. In this way, a simple and reliable adjustment between the draining position and the closing position is achieved.

Practically, the accumulator comprises at least one seal for sealing the drainage path in the closing position. In particular, at least one such seal is arranged in the closing position between the interior space and the drain opening.

The channel body can comprise at least one opening, which in the draining position of the drain valve serves for the draining of temperature-control liquid out of the interior space through the drain opening. Thus, the drainage path in the draining position leads through the mentioned opening which in the following is also referred to as temperature-control liquid drain opening. The temperature-control liquid drain opening is separate from the at least one upper opening and the at least one lower opening. In particular, the at least one temperature-control liquid drain opening is arranged, advantageously formed in the lower section of the channel body.

It is advantageous when the drainage path extends, at least in the draining position, between the channel body, in particular the upper section, and the connector. Thus it is possible in particular to combine the drain opening and the vent opening in a simplified manner. This means that the temperature-control liquid, in the draining position of the drain valve, flows between the connector and the channel body and subsequently through the drain opening or vent opening. In addition, gas, in particular in the venting position, flows through the vent opening or drain opening. In particular it is thus possible, when draining the cooling liquid, i.e. in the draining position, to admit ambient air into the interior space via the channel body at the same time.

Basically, the accumulator can be employed in any application. In particular, the accumulator can be employed in a motor vehicle. In the motor vehicle, the accumulator serves for example for driving the motor vehicle. It is to be understood that besides the accumulator a motor vehicle having such an accumulator is also included in the scope of this invention.

Practically, the motor vehicle comprises a support structure on which the accumulator is attached. Here, the accumulator is preferably attached on the motor vehicle in such a manner that the lower side of the housing, in a Z-direction of the motor vehicle, which corresponds to the height direction, is arranged below the top. Here, the accumulator is attached on the support structure in particular via the top. Thus, the bottom and consequently the vent opening and/or the drain opening and/or the vent valve and/or the drain valve are accessible via the bottom and thus from below. This simplifies in particular the maintenance of the accumulator, i.e. in particular the venting and/or the draining of the temperature-control liquid out of the accumulator. In addition, the accumulator can subsequently be again filled with the temperature-control liquid in a simplified manner in this way.

The support structure can be a support of the motor vehicle, in particular a side member or cross member. The support structure can likewise be a vehicle under body of the motor vehicle.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a highly simplified lateral view of a motor vehicle having an accumulator,

FIG. 2 a section through the accumulator,

FIG. 3 a section through the accumulator in another exemplary embodiment,

FIG. 4 a section through the accumulator in two further exemplary embodiments and in a first state,

FIG. 5 a section through an accumulator in two other exemplary embodiments and in a second state,

FIG. 6 a section through the accumulator in a further exemplary embodiment,

FIG. 7 a partly shown section through the accumulator in a further exemplary embodiment,

FIG. 8 a section through the accumulator in another exemplary embodiment.

### DETAILED DESCRIPTION

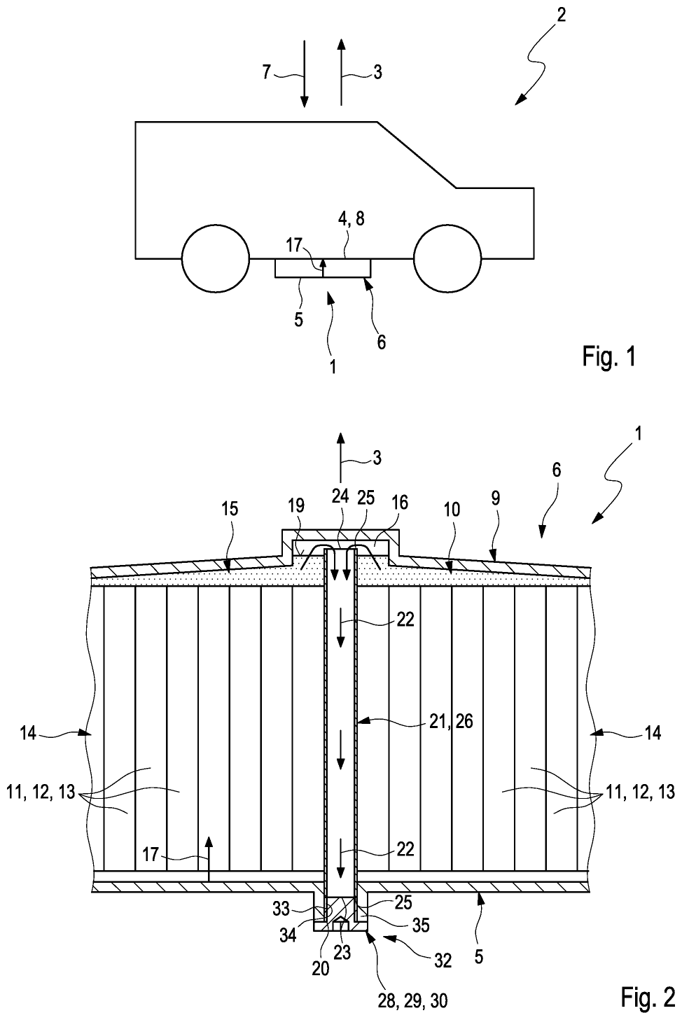

An accumulator 1, such as is shown for example in the FIGS. 1 to 8, is employed in particular in a motor vehicle 2 (see FIG. 1). In the motor vehicle 2, the accumulator 1 can be employed for driving the motor vehicle 1. In particular, an electric drive of the motor vehicle 2 which is not shown can be electrically supplied with the accumulator 1. The accumulator 1 is attached on a support structure 4 in a Z-direction 3 of the motor vehicle 2 in such a manner that a bottom 5 of a housing 6 of the accumulator 1 located at the bottom in Z-direction 3 is arranged at the bottom with respect to the Z-direction 3 or in the vertical direction 7. The support structure 4 can be in particular an under body 8 of the motor vehicle 2.

The FIGS. 2 to 8 each show a section through the accumulator 1, wherein the section leads through the housing 6. Accordingly, the housing 6 has a top 9 located opposite the bottom 5, wherein the bottom 5 and the top 9 delimit an interior space 10 of the accumulator 1. The bottom 5 and the top 9 are spaced apart from one another in a spacing direction 17 of the bottom 5 to the top 9. In the state of the accumulator 1 attached on the vehicle 2, the top 9 is preferably arranged above the bottom 5 with respect to the Z-direction 3. In particular, the bottom 5 follows the top 9 in the vertical direction 7. Advantageously, the spacing direction 17 extends parallel to the Z-direction 3.

In the interior space 10 of the housing 6, the accumulator 1 comprises at least one accumulator cell 11, which is rechargeable. The respective accumulator cell 11 can be for example a pouch cell 12 or a prismatic cell 13. In the shown exemplary embodiments, the accumulator 1 comprises multiple such accumulator cells 11, which are combined into a cell stack 14, also referred to as cell module. Here, the accumulator 1, as in the shown exemplary embodiments, can comprise two or more such cell stacks 14, which are arranged in the interior space 10 next to one another. The interior space 10 of the accumulator 1 is filled with a temperature-control liquid 15, which surrounds the accumulator cells 11, in particular the cell stacks 14.

Here, the temperature-control liquid 15 is merely shown in FIG. 2. In particular, the accumulator cells 11 are immersed in the temperature-control liquid 15. During the operation, the accumulator cells 11 are temperature-controlled, i.e. cooled and/or heated with the temperature-control liquid 15. In particular, the accumulator cells 11 are cooled with the temperature-control liquid 15. In the process, the temperature-control liquid 15 can flow through the interior space 10 during the operation.

In the interior space 10, a gas collection space 16 is formed, furthermore, which is spaced apart from the bottom 5 towards the top 9. The gas collection space 16 is arranged or formed in the spacing direction 17 in the topmost region of the interior space 10. In the shown exemplary embodiments, the gas collection space 16 is delimited at the top 9. In the state of the interior space 10 filled with the temperature-control liquid 15, i.e. in the case of a nominal filling, the gas collection space 16, as indicated in FIG. 2, is additionally delimited by a surface 19 of the temperature-control liquid 15. On the bottom 5 of the housing 6 the accumulator 1 has a vent opening 20 which serves for letting gases out of the gas collection space 16, in particular out of the entire interior space 10. The vent opening 20 is fluidically connected to the gas collection space 16 via a channel body 21, so that a flow path 22 of gas leads between the gas collection space 16 and the vent opening 20 through the channel body 21. For this purpose, the channel body 21 comprises at least one lower opening 23, in the shown examples a sole lower opening 23, and at least one upper opening 24, in the shown examples a sole upper opening 24. The lower opening 23 and the upper opening 24 are spaced apart from one another along the channel body 21. The lower opening 23 is fluidically connected to the vent opening 20 and the upper opening 24 is fluidically connected to the gas collection space 16. The lower opening 23 and the upper opening 24 in this case are advantageously and, as shown, arranged at different ends of the channel body 21. In particular, the openings 23, 24 of the channel body 21 are each arranged or formed on an associated front side 25 of the channel body 21. In the shown exemplary embodiments, the channel body 21 is routed through the interior space 10. Here, the channel body 21 can extend between two consecutive cell stacks 14 as shown.

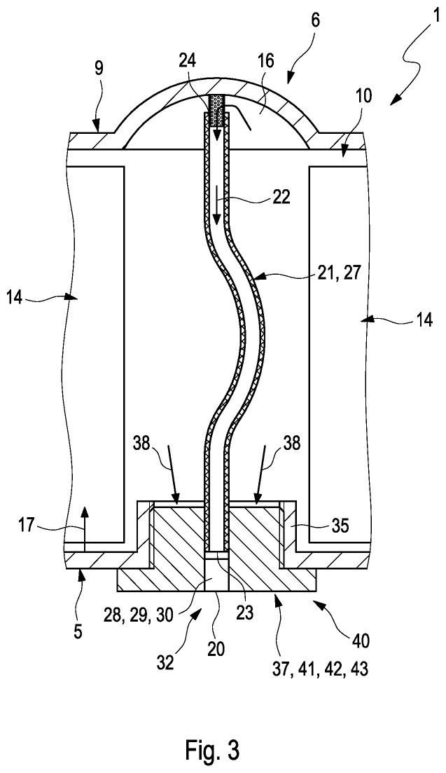

As in the exemplary embodiments of the FIGS. 2 and 4 to 7, the channel body 21 can be formed rigidly, for example as a tubular body 26, but also as in the exemplary embodiment of FIG. 3, flexibly and deformably, for example as a hose 27.

In the shown exemplary embodiments, the top 9 is formed curved towards the outside in the region of the gas collection space 16. Furthermore, the top 9 in the exemplary embodiment of FIG. 2 is formed rising towards the gas collection space 16.

In the shown exemplary embodiments, the accumulator 1 comprises a vent valve 28, which can be formed as a plug 29, in the following also referred to as vent plug 29, or as a screw 30, in the following also referred to as vent screw 30. With the vent valve 28 it is possible to optionally block or open the flow path 22. For this purpose, the vent valve 28 is adjustable between a venting position 31 shown in the FIGS. 5 to 7 and a blocking position 32 shown in the FIGS. 2 and 3 as well as 8. In the blocking position 32, the vent valve 28 blocks the flow path 22, so that no gas can flow via the flow path 22 through the vent opening 20 out of the gas collection space 16 or the interior space 10. In the venting position 31, this flow path 22 is open, so that the gas can flow via the flow path 22 out of the vent opening 20 to the outside. Preferably, in at least one of the positions 31, 32 of the vent valve 28, in particular in the venting position 31, the upper opening 24 of the channel body 21 leads into the gas collection space 16, in particular is arranged in the gas collection space 16. Here, the upper opening 24 in the state filled with the temperature-control liquid 15 is arranged above the surface 19 of the temperature-control liquid 15.

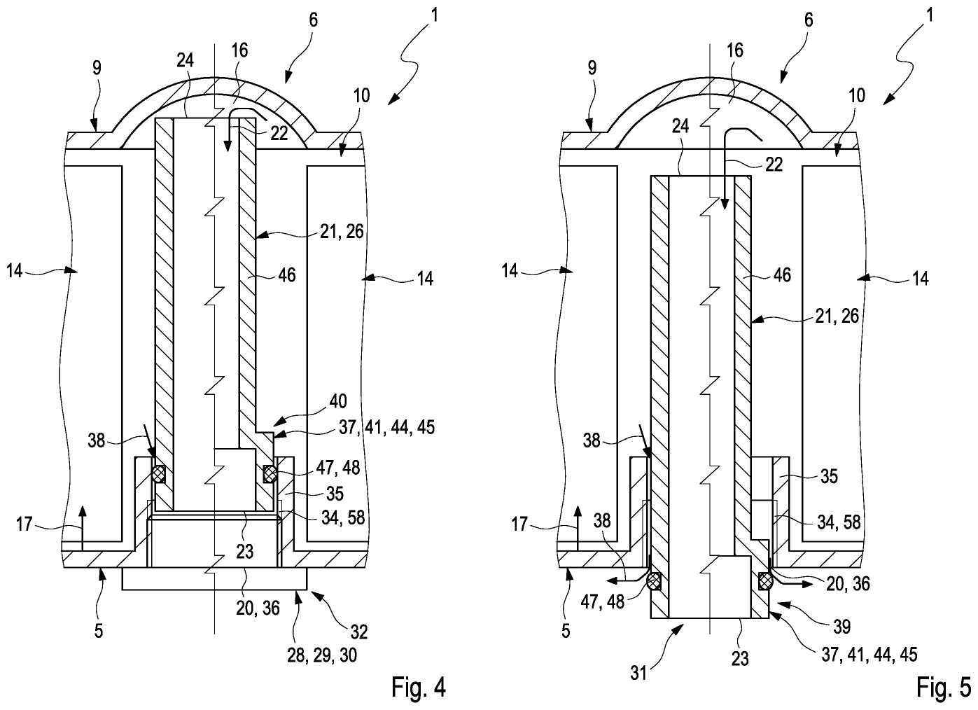

In the shown exemplary embodiments, the adjusting of the vent valve 28 formed as vent plug 29 or vent screw 30 takes place by closing the vent opening 20 in the blocking position 32 and removing the vent valve 28 out of the vent opening 20 in the venting position 31. For this purpose, the vent valve 28, as indicated in FIG. 2 as well as FIGS. 4 and 5, can comprise a thread 33 which interacts with a mating thread 34, for example of the housing 6, in particular the bottom 5.

As is evident from the FIGS. 2 to 8, a connector 35 can be formed on the bottom 5, in particular in the bottom 5, which can project both on the side facing away from the interior space 10 and thus to the outside as well as into the interior space 10 and thus to the inside. In the exemplary embodiments of FIGS. 2 as well as 5 to 7, the connector 35 purely exemplarily projects towards the outside and in the exemplary embodiments of the FIGS. 3 and 4, purely exemplarily to the inside.

As shown in the exemplary embodiments of the FIGS. 3 to 7, the accumulator 1 can comprise a drain opening 36 for draining temperature-control liquid 15 out of the interior space 10. The drain opening 36 is arranged or formed on the bottom 5, in particular in the bottom 5. In these shown exemplary embodiments, the drain opening 36 is formed in the connector 35 in each case. Furthermore, the accumulator 1 comprises a drain valve 37 which optionally blocks and opens a drainage path 38 of temperature-control liquid 15 from the interior space 10 through the drain opening 36. For this purpose, the drain valve 37 is adjustable between a draining position 39 shown in the FIGS. 5 and 7 and a closing position 40 shown in the FIGS. 3 as well as 4 and 6. In the draining position 39, the drain valve 37 opens the drainage path 38 so that temperature-control liquid 15 can flow and thus drained out of the interior space 10 via the drain opening 36. In the closing position 40, the drainage path 38 is blocked so that an outflow of the temperature-control liquid 15 out of the drain opening 36 is prevented.

In the exemplary embodiment show in FIG. 3, the drain valve 37 is formed as a drain closure 41, which in the closing position 40 is inserted into the drain opening 36 and thus closes the drain opening 36. In the draining position 39, which is not visible in FIG. 3, the drain closure 41 is removed out of the drain opening 36, for example pulled out or unscrewed in the spacing direction 17. As a consequence, the drain opening 36 and the drainage path 38 are open. Here, the drain closure 41 can be formed as a plug 42, also referred to as drain plug 42, or as a screw 43, also referred to as drain screw 43.

In the exemplary embodiment shown in FIG. 3, the vent opening 20 is formed in the drain valve 37, in particular in the drain closure 41. Here, the channel body 21 on the end side is inserted into the drain closure 41. Furthermore, in the blocking position 32, the vent valve 28 is arranged in the drain closure 41, in particular the vent plug 29 inserted or the vent screw 30 screwed in. Furthermore, the channel body 21 formed as hose 27 is fastened on the top 9 in the region of the upper opening 24, so that the upper opening 24, upon adjusting of the drain valve 37 into the draining position 39, continues to be fluidically connected to the gas collection space 16, in particular leads into the gas collection space 16.

As is evident from the FIGS. 4 to 7, the vent opening 20 can correspond to the drain opening 36. This means that the vent opening 20 and the drain opening 36 can be identical.

In the exemplary embodiments shown in the FIGS. 4 to 7, the drain valve 37 is formed by the channel body 21.

Here, the FIGS. 4 and 5 in the representation of these figures show different exemplary embodiments on the left and right, which in the respective figure are marked by a zigzag line and separated from one another.

According to the right-hand figure side of the FIGS. 4 and 5, the channel body 21 there comprises a lower section 45 formed as a collar 44, which forms the drain valve 37 and is guided in the connector 35. Accordingly, the lower section 45 of the channel body 21 serving as drain valve 37 is adjustable between the draining position 39 shown in FIG. 5 and the closing position 40 shown in FIG. 4. Furthermore, the channel body 21 comprises an upper section 46 on the side of the lower section 45 facing the top 9, which follows the lower section 45. The upper section is annular in shape and has a smaller outer cross section compared with the lower section 45. Here, the lower section 45 comprises the lower opening 23 and the upper section 46 the upper opening 24.

By contrast with this, the channel body 21 according to the left-hand figure side of the FIGS. 4 and 5 does not have an upper section 46 and lower section 45 with different outer cross sections. This means that the channel body 21 has a constant outer cross section.

FIG. 4 shows the blocking position 32 of the vent valve 28 and the closing position 40 of the respective drain valve 37 and thus of the lower section 45. FIG. 5 shows the venting position 31 and the draining position 39 of the respective drain valve 37. As is shown by a comparison between the FIGS. 4 and 5, the vent valve 28, for venting, can be adjusted into the venting position 31, in particular removed out of the vent opening 20 and thus out of the drain opening 36. When the drain valve 37 remains in the closing position 40, merely a venting of the gas collection space 16 or of the interior space 10 takes place. In the exemplary embodiments shown in the FIGS. 4 and 5, the lower section 45 of the respective channel body, in the closing position 40, is arranged in the connector 35. In addition, a seal 47, in particular a ring seal 48, is received on the outside of the lower section 45, which seals, in the closing position 40 within the connector 35, against the connector 35 and thus prevents the flow of the temperature-control liquid 15 in the direction of the drain opening 36.

An adjusting of the drain valve 37 and thus of the lower section 45 into the draining position 39 in these exemplary embodiments can only take place in particular when the vent valve 28 is adjusted into the venting position 31, in particular has been removed out of the vent opening 20 and thus out of the drain opening 36. When, as shown in FIG. 5, the drain valve 37 and thus the lower section 45 is adjusted into the draining position 39, temperature-control liquid 15 can flow out of the interior space 10 out of the drain opening 36. In the draining position 39, the lower section 45 is arranged outside the connector 35. Thus, the sealing ring 47 does not seal in the draining position 39 so that the drainage path 38 is open and the temperature-control liquid 15 flows out of the interior space 10 through the connector 35 out of the drain opening 36. In the exemplary embodiment shown on the right side of the FIGS. 4 and 5, the reduced outer cross section of the upper section 46, as can be seen in FIG. 5, results in that in the draining position 39 a larger volume flow of the temperature-control liquid 15 can flow out of the interior space 10 and out of the drain opening 36. As shown in the FIGS. 4 and 5 it is possible, furthermore, to provide an expansion 58 inside in the region of the connector 35 that is distant from the interior space 10 so that the inner cross section of the connector 35 is enlarged by the expansion 58. The expansion 58 is in particular the mating thread 34. When the lower section 45 is adjusted so that the seal 47 is arranged in the region of the expansion 58, the seal 47 does not or not completely seal, so that temperature-control liquid 15 can already flow out of the interior space 10 through the connector 35 out of the drain opening 36. Thus, the draining position 39 already commences earlier or is configured in steps. Here, the drainage path 38 extends in each case between the connector 35 and the upper section 46. In the draining position 39, air from the surroundings can flow at the same time through the channel body 21 into the interior space 10 and thus simplify the drainage of the temperature-control liquid 15 out of the interior space 10.

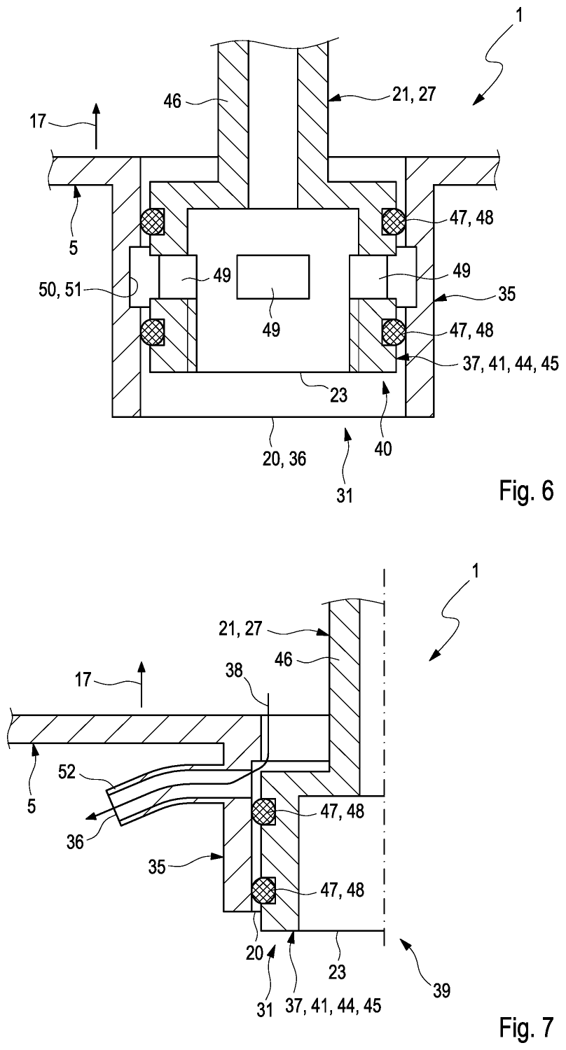

The exemplary embodiment shown in FIG. 6 differs from the exemplary embodiment shown on the right side of the FIGS. 4 and 5 in particular in that for adjusting the lower section 45 into the draining position 39 not shown in FIG. 6 the lower section 45 need not be adjusted out of the connector 35. For this purpose, the lower section 45 comprises at least one temperature-control liquid drain opening 49 that is separate from the lower opening 23, wherein in the shown exemplary embodiment two or more such temperature-control liquid drain openings 49 are arranged. On the inside, the connector 35 comprises a local recess 50 which can be formed as an annular groove 51 that is open towards the inside. In the shown exemplary embodiment, two seals 47 that are spaced apart from one another, in particular ring seals 48, are arranged on the outside of the lower section 45, between which the at least one temperature-control liquid drain opening 49 is arranged. In the draining position 39, the seal 47 next adjacent to the top 9 is arranged in the recess 50 so that temperature-control liquid 15 circulates about the upper seal 47 in the recess 50 and flows into the channel body 41 via the at least one temperature-control liquid drain opening 49. Following this, the temperature-control liquid flows via the lower opening 23 out of the drain opening 36. Here, FIG. 6 merely shows a section in the region of the bottom 5. In particular, the cell stacks 14 are not shown.

As is evident from FIG. 7, the drain opening 36 in the connector 35 can also be spaced apart from the vent opening 20. Here, FIG. 7 merely shows a section in the region of the bottom 5. In particular, the cell stacks 14 are not shown. The exemplary embodiment shown in FIG. 7, therefore differs from the exemplary embodiment shown in FIG. 6 in particular in that the drain opening 36 is separate from the vent opening 20. Here, the drain opening 36 is formed in a drain 52 laterally projecting from the connector 35. In the draining position 39 shown in FIG. 7, the upper seal 47 is situated below the drain 52, so that temperature-control liquid 15 flows via the connector 35 into the drain 52 and out of the drain opening 36. In the exemplary embodiment shown in FIG. 7, the lower section 45 is adjusted in the closing position 40 that is not shown, in the direction of the interior space 10 in such a manner that the upper seal 47 is arranged above the drain 52, i.e. moved towards the top 9 and thus blocks the drainage path 38.

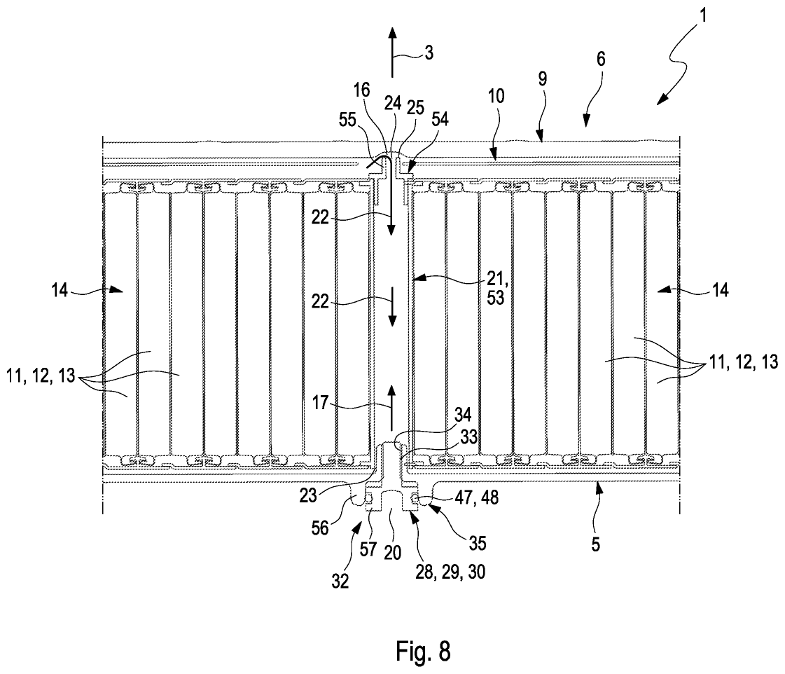

In the exemplary embodiment of FIG. 8, the channel body 21 comprises an integrally formed hollow chamber profile 53 between two adjacent cell stacks 14 and an end cap 54. The hollow chamber profile 53 can also be integrally formed within a cell stack 14 (not shown). The end cap 54 is plugged on at the end of the hollow profile 53 facing the gas collection space 16 and fluidically connects the hollow chamber profile 53 with the gas collection space 16. In the shown exemplary embodiment, the end cap 54 comprises a connector-like projection 55, which projects in the direction of the gas collection space 16 and leads into the gas collection space 16. Thus, the end cap 54 comprises the upper opening 24 of the channel body 21. The hollow chamber profile 53 comprises the lower opening 23 of the channel body 21 and with the lower opening 23 is connected to the vent opening 20.

In the exemplary embodiment shown in FIG. 8, a seal 47, in particular ring seal 48, is received in the vent valve 28, which is formed in particular as vent plug 29 or vent screw 30, on the outside transversely to the spacing direction 17, which ring seal 48 seals in the blocking position 32 against the connector 35. Purely exemplarily, the connector 35 in this exemplary embodiment projects both from the side facing away from the interior space 10 and thus to the outside and also from the interior space 10 and thus to the inside. On the side facing away from the interior space 10, the connector 35 is enlarged and thus forms a receptacle 56. The vent valve 28 has a head 57, wherein the head 57 of the vent valve 28 is arranged, in the blocking position 32, in the receptacle 56 so that the seal 47 is sealingly subjected to mechanical load between the head 57 and the receptacle 56.

1. An accumulator for a motor vehicle, comprising:
at least one rechargeable accumulator cell,
a housing that defines an interior space, the at least one accumulator cell arranged in the interior space,
the housing having a top and a bottom located opposite the top,
the interior space of the housing during the operation being filled with a temperature-control liquid, which surrounds and temperature-controls the at least one accumulator cell,
the housing, on the bottom, comprises a vent opening for venting the interior space,
a channel body having at least one lower opening and at least one upper opening,
the at least one lower opening being fluidically connected to the vent opening,
the at least one upper opening being fluidically connected to a gas collection space in the interior space that is spaced apart from the bottom towards the top, so that a flow path extends between the gas collection space and the vent opening through the channel body.

2. The accumulator according to claim 1, further comprising a vent valve adjustable between a venting position and a blocking position, wherein the vent valve opens the flow path in the venting position and blocks the flow path in the blocking position.

3. The accumulator according to claim 1, wherein:
the bottom of the housing comprises a drain opening for draining the temperature-control liquid out of the interior space, and
further comprising a drain valve adjustable between a draining position and a closing position, wherein the drain valve in the draining position opens a drainage path of the temperature-control liquid extending between the interior space and the drain opening and blocks the drainage path in the closing position.

4. The accumulator according to claim 3, wherein the drain valve includes a drain closure that is adjustable between the draining position and the closing position.

5. The accumulator according to claim 3, wherein the vent opening is disposed in the drain valve.

6. The accumulator according to claim 3, wherein the vent opening corresponds to the drain opening.

7. The accumulator according to claim 3, wherein:
the drain opening and the vent opening are disposed in a connector, and
the channel body includes the drain valve and is adjustable in the connector between the draining position and the closing position.

8. The accumulator according to claim 7, wherein:
the channel body includes a lower section that is movable in the connector having the at least one lower opening, and the lower section forms the drain valve, and
the channel body on a side of the lower section facing the top has an upper section with an outer cross section that is smaller compared with the lower section.

9. The accumulator according to claim 3, wherein the channel body includes a temperature-control liquid drain opening that is distinct from the at least one upper opening and the at least one lower opening, through which the drainage path leads in the draining position.

10. The accumulator according to claim 7, wherein the drainage path extends between the channel body and the connector.

11. The accumulator according to claim 1, wherein the gas collection space, in a spacing direction from the bottom to the top, defines a topmost region of the interior space.

12. A motor vehicle, comprising:
a support structure;
an accumulator, the accumulator including:
at least one rechargeable accumulator cell;
a housing that defines an interior space, the at least one accumulator cell arranged in the interior space;
the housing having a top and a bottom located opposite the top;
the interior space of the housing during the operation being filled with a temperature-control liquid, which surrounds and temperature-controls the at least one accumulator cell;
the housing, on the bottom, having a vent opening for venting the interior space;
a channel body having at least one lower opening and at least one upper opening;
the at least one lower opening being fluidically connected to the vent opening;
the at least one upper opening being fluidically connected to a gas collection space in the interior space that is spaced apart from the bottom towards the top, so that a flow path extends between the gas collection space and the vent opening through the channel body; and
wherein the accumulator is attached to the support structure such that the bottom, in a Z-direction, is arranged below the top.

13. The motor vehicle according to claim 12, further comprising a vent valve adjustable between a venting position and a blocking position, wherein the vent valve opens the flow path in the venting position and blocks the flow path in the blocking position.

14. The motor vehicle according to claim 12, wherein the bottom of the housing has a drain opening for draining the temperature-control liquid out of the interior space; and
further comprising a drain valve adjustable between a draining position and a closing position, wherein the drain valve in the draining position opens a drainage path of the temperature-control liquid extending between the interior space and the drain opening and blocks the drainage path in the closing position.

15. The motor vehicle according to claim 14, wherein the drain valve includes a drain closure that is adjustable between the draining position and the closing position.

16. The motor vehicle according to claim 14, wherein the vent opening is disposed in the drain valve.

17. The motor vehicle according to claim 14, wherein the vent opening corresponds to the drain opening.

18. The motor vehicle according to claim 14, wherein:
the drain opening and the vent opening are disposed in a connector; and
the channel body includes the drain valve and is adjustable in the connector between the draining position and the closing position.

19. The motor vehicle according to claim 18, wherein:
the channel body includes a lower section that is movable in the connector having the at least one lower opening, and the lower section forms the drain valve; and
the channel body on a side of the lower section facing the top has an upper section with an outer cross section that is smaller as compared to the lower section.

20. The motor vehicle according to claim 18, wherein the drainage path extends between the channel body and the connector.
